(19) United States
(12) Patent Application Publication
(10) Pub. No.: US 2012/0307962 A1
(43) Pub. Date: Dec. 6, 2012

(54) SYSTEMS AND METHODS FOR X-RAY FLUORESCENCE COMPUTED TOMOGRAPHY IMAGING WITH NANOPARTICLES

(75) Inventor: Sang Hyun Cho, Atlanta, GA (US)

(73) Assignee: Georgia Tech Resarch Corporation, Atlanta, GA (US)

(21) Appl. No.: 13/517,043

(22) PCT Filed: Dec. 16, 2010
(86) PCT No.: PCT/US10/60824

§ 371 Date: Jul. 31, 2012

Related U.S. Application Data
(60) Provisional application No. 61/286,970, filed on Dec. 16, 2009.

(51) Int. Cl. G01N 23/223; B82Y 35/00

(52) U.S. Cl. 378/6; 977/901

(57) ABSTRACT

X-ray fluorescence computed tomography (XFCT) using polychromatic x-rays is provided herein. The XFCT of the presently disclosed subject matter allows for the imaging of various cells loaded with metallic nanoparticles using polychromatic diagnostic energy x-rays. Both imaging of nanoparticles distributed within a cell and the quantification of nanoparticle concentration within the cell, in some configurations, may be accomplished. The x-ray source may, in some examples, provide a pencil beam or a cone/fan beam x-ray configuration.

### CROSS-REFERENCE TO RELATED APPLICATION

The present application claims the benefit of U.S. Provisional Patent Application Ser. No. 61/286,970, filed 16 Dec. 2009, the entire contents of which are incorporated herein as if fully set forth below.

### FIELD OF INVENTION

The various embodiments relate generally to x-ray fluorescence computed tomography (XFCT).

### BACKGROUND

Nanoparticles can passively leak into and accumulate within various cells within an organism, such as a tumor interstitium, from blood vessels feeding the cells. The reason is that nanoparticles are typically smaller (e.g., 1˜100 nm) than the normal cutoff size of the pores (e.g., up to 400 nm) in the cell vasculature. This phenomenon may also be known as “enhanced permeability and retention (EPR)” and has become the basis for so-called “passive targeting” of tumors by nanoparticles. The tumor specificity of nanoparticles can be further increased through so-called “active targeting”, in which nanoparticles are conjugated with antibodies or peptides directed against tumor or angiogenesis markers such as epidermal growth factor receptor (EGFR), vascular endothelial growth factor receptor (VEGFR), etc. In recent years, there has been a growing interest in applying these targeting strategies to cancer treatment and detection. For example, tumor cells have been targeted passively or actively for therapy and/or imaging purposes during in vivo experiments using various forms (e.g., sphere, shell, rod, etc.) of metal, semi-conductor, and polymer nanoparticles.

### BRIEF SUMMARY

The subject matter provided herein discloses x-ray fluorescence computed tomography for molecular imaging of various cells loaded with metallic nanoparticles using polychromatic diagnostic energy x-rays. In some configurations, systems and methods according to the presently disclosed subject matter provide for the imaging of nanoparticles distributed within a cell or the quantification of nanoparticle concentration within the cell, or both. In some configurations, the nanoparticle is a gold nanoparticle. In some configurations, the cell is a cancerous tumor.

One example of the presently disclosed subject matter includes a method of performing x-ray fluorescence computed tomography of a plurality of metallic nanoparticles within a cell. Pluralities of nanoparticles are introduced in the cell, typically through pores in the cellular membrane. The nanoparticles are preferably sized and configured to not only have an affinity for the cell, but also have a size small enough to be able to enter the cell through a pore in the cellular membrane. A polychromatic x-ray source at diagnostic energy levels is energized to cause x-ray fluorescence of the nanoparticles. X-ray fluorescence from the nanoparticles is measured by an energy-resolving detector system. Various photon energy bandwidths associated with x-ray fluorescence peaks of metals are filtered to provide for the ability to determine the concentration of the nanoparticles within the cell. Further, the cell is moved in relation to the x-ray source and the detector to provide for the ability to determine the spatial distribution of the nanoparticles.

In another example, the presently disclosed subject matter provides for a system configured for x-ray fluorescence computed tomography of a plurality of metallic nanoparticles within a cell. In some embodiments, the system has a polychromatic x-ray source configured to provide x-ray energy at diagnostic energy levels. Further, the system has a photodiode detector configured to detect x-ray fluorescence of the plurality of nanoparticles within the cell. To reduce background x-ray photons, shielding or collimation is disposed proximate to the detector.

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE FIGURES

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 illustrates an exemplary and non-limiting method for x-ray fluorescence computed tomography using an x-ray source outputting polychromatic x-rays.

FIG. 2 is an illustration of an exemplary and non-limiting system configured for x-ray fluorescence computed tomography according to the presently disclosed subject matter.

FIGS. 3a and 3b show x-ray spectra of a collimated incident primary beam from a polychromatic x-ray source before and after filtration, respectively, as measured using a CdTe photodiode detector.

FIG. 4 is a graphical illustration of the travel path of photons in relation to a detector.

FIG. 5a shows an exemplary fluorescence spectrum from a test subject.

FIG. 5b shows data in specific portions of the spectrum of FIG. 5a.

FIG. 6a shows gold K-fluorescence spectra obtained for a sample having three difference concentrations of gold nanoparticles.

FIG. 6b illustrates normalized fluorescence counts as a function of gold nanoparticle concentration.

FIG. 7 is a sinogram for gold nanoparticle K-fluorescence lines obtained in the data shown in FIG. 6a for gold nanoparticle concentrations of 1 weight percent and 2 weight percent.

FIG. 8 shows a reconstructed image of the gold nanoparticles illustrating the location of the gold nanoparticles within the test subject.

FIG. 9 illustrates the use of a cone/fan beam, polychromatic x-ray source using a collimated array detector.

FIG. 10 illustrates the use of a cone/fan beam, polychromatic x-ray source using multiple collimated array detectors.

Any headings provided herein are for convenience only and do not necessarily affect the scope or meaning of the claimed presently disclosed subject matter.

### DETAILED DESCRIPTION

The subject matter of the various embodiments is described with specificity to meet statutory requirements. However, the description itself is not intended to limit the scope of this patent. Rather, it has been contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

It should also be noted that, as used in the specification and the appended claims, the singular forms “a,” “an” and “the” include plural references unless the context clearly dictates otherwise. For example, reference to an ingredient is intended also to include composition of a plurality of ingredients. References to a composition containing “a” constituent is intended to include other constituents in addition to the one named. Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, other exemplary embodiments include from the one particular value and/or to the other particular value. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

As used herein the term “nanoparticle” is intended to encompass all amorphous and crystalographically ordered particulates regardless of their shape and having an average longest dimension of less than or equal to about 1000 nm. This includes individual element particulates, (e.g., metals, metalloids, and non-metals); binary compound particulates, multinary compound particulates, alloy particulates, polymeric particulates, composite or hybrid particulates, and the like. The term nanoparticles is also intended to encompass a variety of shapes, including, but not limited to solid spheres, hollow spheres, spherical core-shells, solid rods, hollow rods, solid cubes, solid cubic cages, solid stars, solid triangular prismatic plates (e.g., nanopyramids), solid ellipsoids, hollow ellipsoids, core-shell ellipsoids, solid rings, solid hemispheres, solid circular disks, solid ellipsoidal rings, among others.

In an embodiment, the nanoparticle comprises a metal. The metal may be selected from a metal in groups IA, IB, IIB and IIIB of the periodic table, as well as the transition metals, especially those of group VIII. Preferred metals include gold, silver, aluminum, platinum, copper, ruthenium, zinc, iron, nickel, and calcium. Other suitable metals also include the following in all of their various oxidation states: lithium, sodium, magnesium, potassium, scandium, titanium, vanadium, chromium, manganese, cobalt, gallium, strontium, niobium, molybdenum, palladium, indium, tin, tungsten, rhenium, and gadolinium. The metals are preferably provided in ionic form and derived from an appropriate metal compound.

A preferred metal is gold. In one embodiment, the gold nanoparticles have a negative charge at an approximately neutral pH. It is thought that this negative charge prevents the attraction and attachment of other negatively charged molecules. In contrast, positively charged molecules are attracted to and bind to the gold particle. In such preferred embodiment, a gold nanoparticle may have an average longest dimension of about 1 nanometer to about 1,000 nanometers, and more preferably about 1 nanometer to about 150 nanometers. In an exemplary embodiment, a gold nanoparticle comprises a solid sphere having an average hydrodynamic diameter of about 2 nanometers to about 100 nanometers. It should be understood that the presently disclosed subject matter is not limited to any particular nanoparticle geometry. For example, and not by way of limitation, the presently disclosed subject matter may also use nanoparticles in the shape of nanorods and nanoshells.

Nanoparticles made of gold might be of particular interest because they are fabricated from an inert metal (i.e., gold) and, as a result, are biologically non-reactive and molecularly stable. Moreover, gold nanoparticles exhibit two unique physical properties to ionizing radiation and near-infrared light through photoelectric effect and photothermal effect, resulting in radiation dose enhancement and heat generation, respectively. Consequently, over the years, some therapeutic approaches based on these properties have been proposed for the treatment of cancers.

The presently disclosed subject matter discloses a way to provide for simultaneous or near-simultaneous (a) in-vivo imaging of gold-nanoparticles (GNP) distributed within the tumor and other critical organs and (b) in-vivo quantification of the amount of GNPs present within the tumor and other critical organs. In conventional x-ray fluorescence computed tomography (XFCT), characteristic x-rays (i.e., x-ray fluorescence photons) are initially induced from a sample containing one or more elements in question by monochromatic x-rays such as those from synchrotrons and, subsequently, the spatial distribution and concentration of each element are determined through a full three dimensional image reconstruction process.

The presently disclosed subject matter uses polychromatic x-rays at diagnostic energy levels (e.g., 110 kVp) instead of the monochromatic x-rays used in the current art. For the purposes of the presently disclosed subject matter, polychromatic means that the x-ray source outputs a relatively broad spectrum of x-ray energies.

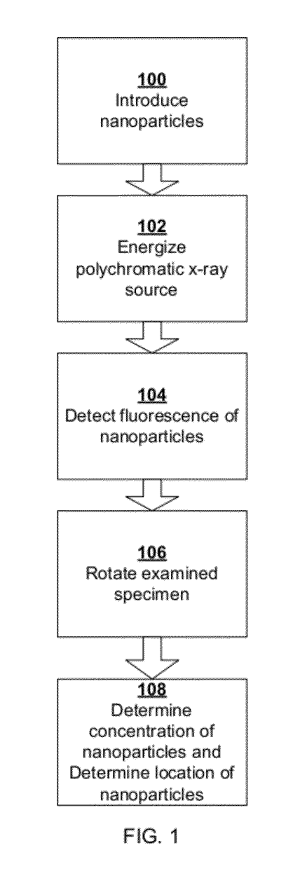

FIG. 1 illustrates an exemplary method for XFCT that uses polychromatic x-rays instead of monochromatic x-rays. In a body, for example, a tumor, gold nanoparticles are introduced 100 into the tumor. It should be noted that although the following description uses gold nanoparticle as the nanoparticle of choice, the description should not be viewed as intent to limit the scope of the subject matter to only the use of gold nanoparticles. Other suitable nanoparticle structures and compositions may be used. Although concentrations of gold nanoparticles may vary, in the presently disclosed subject matter, gold nanoparticles may be introduced at levels providing for low gold nanoparticle concentrations in the cell. A polychromatic x-ray source is energized 102 to cause x-ray fluorescence of the gold nanoparticles within the cell. The x-ray fluorescence is caused by the absorption of incident x-ray energy by the gold nanoparticles. A detector detects 104 the gold nanoparticle fluorescence. The detector is placed at an angle, typically less than or equal to 90°, between the x-ray beam and the detector to minimize the unwanted scattered photons entering the detector. To reduce the amount of background noise further, shielding or collimation around the detector may be used. For example, although the detector may be aligned to attempt to only detect fluorescence from the gold nanoparticles, in a typical environment, there is background noise from Compton and elastically scattered x-rays and x-ray fluorescence from other elements in a test subject. Shielding or collimation placed around the detector may help reduce such noise.

Although it may be optional depending on the particular cellular structure being examined, the cell or cells undergoing testing may be rotated in relation to the test apparatus. Alternatively, the test apparatus may be rotated around the cell or cells that remain stationary during the testing. This helps provide a 360 degree or fully circumferential “look” at the cell or cells undergoing testing. The data collected not only helps in the determination 108 of the concentration of the gold nanoparticles within the cell or cells being examined, but also, the location of the gold nanoparticles. Thus, the presently disclosed subject matter provides for the imaging of gold nanoparticles distributed within a tumor (or other critical cells) and the quantification of the amount of gold nanoparticles present within the tumor (or other critical cells).

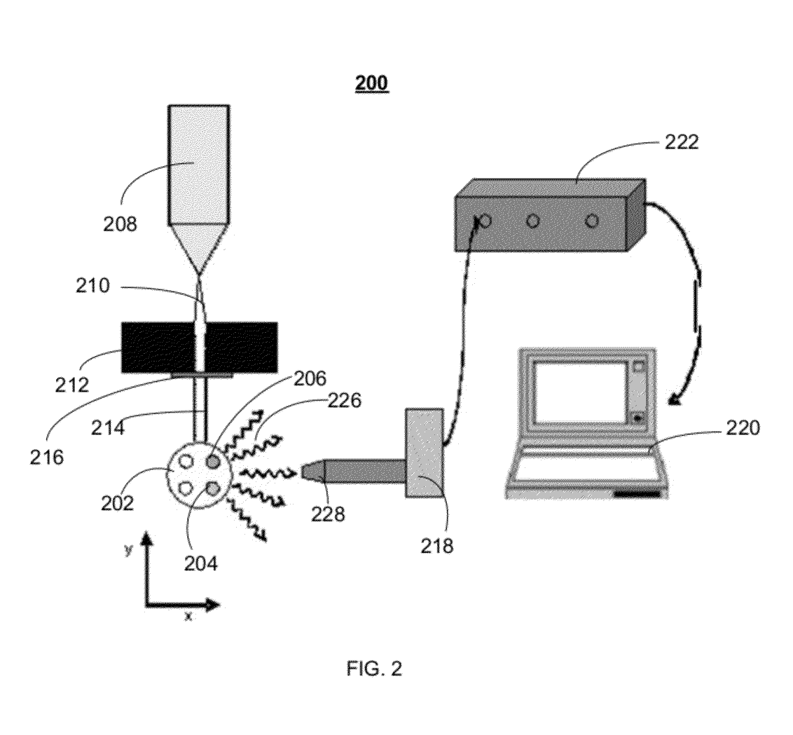

FIG. 2 is an exemplary system that may be used to provide for XFCT using polychromatic x-rays at diagnostic energy levels. Although the following description discloses an exemplary test setup using a phantom in lieu of tissue, it should be noted that the presently disclosed subject matter is suitable for use in various testing situations. Saline solutions containing gold nanoparticles at 1% and 2% by weight were prepared using commercially available GNPs with 1.9 nm diameter. The weight fractions of GNPs in the samples were selected considering the results from a previous animal study for possible tumor/blood gold concentration levels in vivo. After each solution was poured into a cylindrical sample container of 1 cm and 4 cm in diameter and height, respectively, the sample containers were sealed and inserted into designated cylindrical columns 204 and 206 within a phantom 202 made of Polymethyl Methacrylate (PMMA) plastic as shown in FIG. 2. The dimension of phantom 202 was 5 cm in both diameter and height. The centers of four equidistant slots for sample containers (90° apart) with 1.05 cm in diameter and 2.5 cm in height were located at 1.5 cm from that of the phantom 202. As can be seen in FIG. 2, two adjacent columns 204 and 206 were filled with 1 and 2 weight % GNPs while the other two were occupied by plastic plugs made of PMMA, the same material used for the phantom 202.

### Experiment Setup and Results

X-ray beams were generated by a Hamamatsu Microfocus X-ray Source (L9631, Hamamatsu Photonics, Inc.) 208 operating at 110 kVp and a tube current of 455 μA. Source 208 had a microfocus x-ray tube with a focal spot size less than 100 μm and an emission angle of 62°. The x-ray beam 210 produced by source 208 was collimated by collimator 212 comprising cylindrical hole of 5 mm in diameter through a lead block with a dimension of 10×10×5 cm³ to produce a pencil beam 214 after the collimation. It should be noted that although system 200 uses collimator 212 to collimate the x-ray beam 210 produced by source 208, system 200 is not limited to the use of a collimator.

Continuing with the exemplary experimental setup, distance from x-ray source 208 to the entrance surface (toward the source) of collimator 212 and that from the exit surface (toward the phantom 202) of the collimator 212 to the center of the phantom 202 were 2.4 and 5.6 cm, respectively, resulting in total distance of 13 cm between the source 208 and the center of the phantom 202 including the collimator 212 thickness of 5 cm. The size of the beam 214 became larger than that of the collimator 212 at a distance from its exit due to the divergent nature of the beam 214. As a result, a beam 214 size of 1 cm in diameter at the center of phantom 202 was observed, the same width of the gold column inside the phantom 202. For measurement purposes as discussed later, 680 μm thick lead filter 216 was placed at the exit of the collimator 212 as an attenuator to reduce the unnecessary x-ray photons with energies below gold K-absorption edge (80.7 keV).

The phantom 202 was rotated and translated in precise steps with the stages while the x-ray source 208 and the detector 218 were stationary. In this exemplary setup, the rotational and translational stages were motorized with a minimum incremental motion of 2.19 arcsec and a resolution of ˜100 nm, respectively. The rotation and translation of the phantom 202 were controlled by motor-driving software. Data acquisition was paused during the movement of the stages to the next rotational or translational positions after the data collection for 60 seconds at each position. During the experiment, the collimated x-ray beam 214 irradiated the phantom 202 at a given view angle θ. After the completion of a scan at each position, the phantom 202 was rotated by a small angular increment Δθ (normally 6°) and the scanning process resumed again. This process was repeated until a full 360° rotation was completed. Subsequently, the scanning process continued while the phantom 202 was being translated by a 5 mm step over 5.0 cm along the axis normal to the beam direction, which covered the whole size of the phantom 202.

Detector 218 was configured to capture the weak x-ray fluorescence signals from the phantom 202 containing GNPs at low concentration. Detector 218 comprised an x-ray detector, preamplifier, and cooler system using a thermoelectrically cooled CdTe photodiode, not shown. Detector 218 uses a digital pulse processor and multichannel analyzer 222 as an interface between the detector 218 and data acquisition computer 220 for data acquisition, control, and x-ray spectral data analysis.

As discussed previously, for x-ray fluorescence measurement, there are typically background counts from Compton and elastically scattered x-rays and x-ray fluorescence from other elements in a test subject. For a system of absorbing atoms at low concentration (e.g., 1 or 2 weight % GNPs suspended in saline solution within the phantom 202), this background level may be too high relative to the height of the gold fluorescence. In order to reduce the background, the combination of an optimal experimental geometry and a proper shielding for the detector may be used. In one example, the geometry may be optimized by making an angle of about 90° between the x-ray beam 214 and the detector 218 in order to attempt to minimize the unwanted scattered photons 226 entering the detector. Second, a conically shaped lead shield 228 with an opening end of 5 mm in diameter was built and used to cover the detector 218 stem (not shown) for an additional reduction in the detection of Compton-scattered photons from the phantom 202. In an exemplary use, this detector shield 228 significantly improved the gold fluorescence signal-to-background ratio by more than 100%.

In the exemplary system 200, available x-ray fluorescence lines from gold were peaked at 9.7, 11.4, 67.0, 68.8, and 77.9 keV corresponding to Au Lα, Lβ, Kα2, Kα1, and Kβ, respectively. Considering the half-value layer (HVL) values of PMMA, 2.46 and 32.7 mm for x-rays with 11.0 and 70.0 keV, respectively, an observation of Au L-fluorescence lines are typically not practical due to their limited penetration through the PMMA phantom 202. For example, only 6% of x-rays with 11.0 keV survives after traveling through 1 cm of PMMA compared to 80% of x-ray transmission at 70.0 keV with the same thickness of PMMA. Thus, in some uses, it may be preferable to focus on acquiring Kα peaks (67.0 and 68.8 keV) to take advantage of their strongest fluorescence yields as well as their penetrability through the PMMA phantom 202, or other cells, as mentioned above. It should be noted that gold L-fluorescence lines may still be used for XFCT imaging of certain objects, including objects smaller than the phantoms of the present experiment, as long as gold L-fluorescence photons can be detectable outside the object.

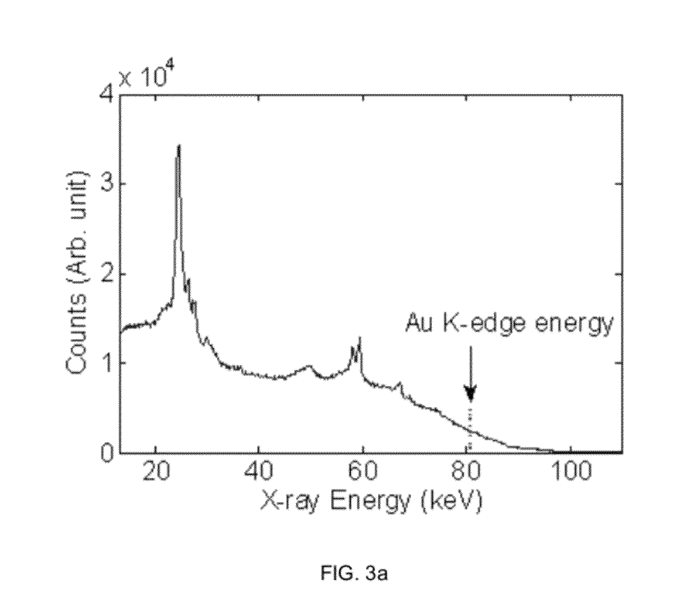

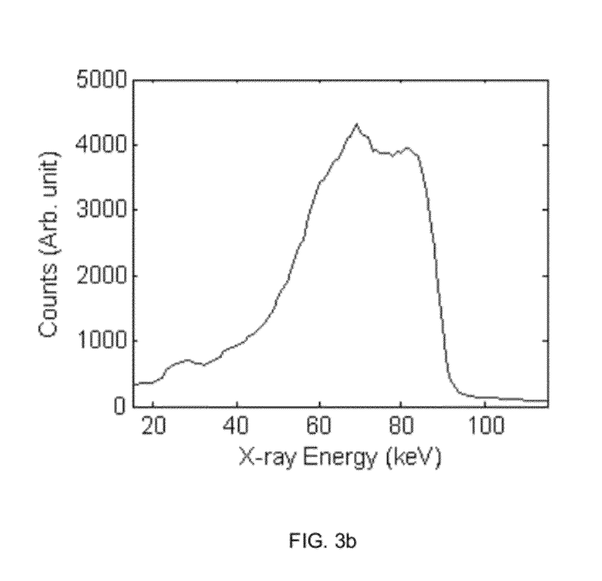

FIGS. 3a and 3b show the spectra of a collimated incident primary beam from the x-ray source as measured using the CdTe photodiode detector before and after filtration, respectively. As can be seen in FIG. 3a, the x-ray photons above “Au K-edge” (˜80.7 keV), which are capable of generating Au K-fluorescence, occupy only 8% of the total fluence of the primary beam. The incident x-ray photons with energies below Au K-absorption edge are, in some cases, undesirable because they may represent the unwanted scattering background counts during measurement of Au Kα fluorescence lines if they are not properly removed or reduced. Reducing the undesired scattering can be performed by placing a filter material on the passage of the incident beam, such as filter 216 in FIG. 2. The 680 μm thick lead filter 216 attached to the exit of the collimator 212 required a tradeoff between removing the low energy x-rays and sustaining the fluence of x-rays above Au K-edge. The spectrum of the incident beam 214 filtered with 680 μm thick lead 216 is shown in FIG. 3b. It should also be mentioned that the number of fluorescence counts from the element of interest in tomography is obtained by the line integral of the concentration along the line traversed by the pencil beam. This integration process of the present example was accomplished by translation of the detector by 1 cm steps and repetition of measurements over 5.0 cm along y-axis in FIG. 2 (parallel to the pencil beam direction), which covered the whole size of the phantom along the beam direction.

After traveling through a medium, x-ray photons reaching the detector typically experience reduction in counts due to the absorption by the elements inside the phantom 202. Since the attenuation effect may distort the fluorescence by reducing the amplitude, a quantitative tomographic reconstruction may require correction for the fluorescence produced by GNPs as well as the scattered x-ray photons. The magnitude of the attenuation effect depends on the x-ray optics, collimation, the photon energy, the detector response function and on the atomic number, quality, and thickness of the absorbing material.

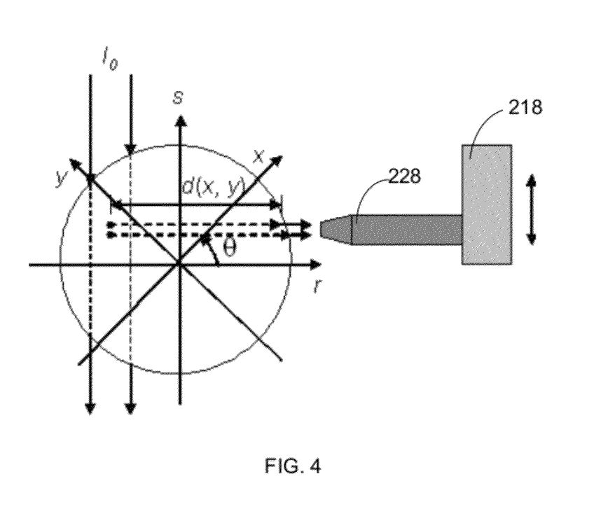

In the present example, detector 218 with a conically-shaped shield 228 was aimed for receiving the directional beam. At each point along the beam path, the Au fluorescence photons were emitted proportional to the concentration of Au. To be detected, the fluorescence photons that were emitted into the solid angle Ω of the detector should travel a part of the phantom d(x, y) as depicted in FIG. 4 depending on the positions of the incident beam (x) and the detector (y) with the given experimental setup. Both scattered and fluorescence photons entering the detector were attenuated according to

η_{E}(x,y)=T_{E}exp(−μ_{E}·d(x,y)), (1)

where T_{E}, μ_{E} and d(x, y) are the unattenuated photon counts, the linear attenuation coefficient at energy E, and the travel distance inside the phantom, respectively. The linear absorption coefficient (μ_{E}) was determined using the mass attenuation coefficient

$$( \frac{{μ}_{E}}{ρ} )$$

for PMMA and its density (ρ) of 1.19 (g/cm³). Thus, the measured photon counts η_{E}, within the energy of interest (typically 60 to 80 keV), may be corrected by Eq. (1). Considering the energy of interest, the attenuation due to the air gap between the phantom and the detector was negligible and, therefore, may be disregarded. Although not implemented for the exemplary system 200, the attenuation corrections for XFCT can be accomplished during routine applications by employing a transmission detector as adopted in conventional transmission CT that produces necessary information to determine an attenuation map of the imaged object.

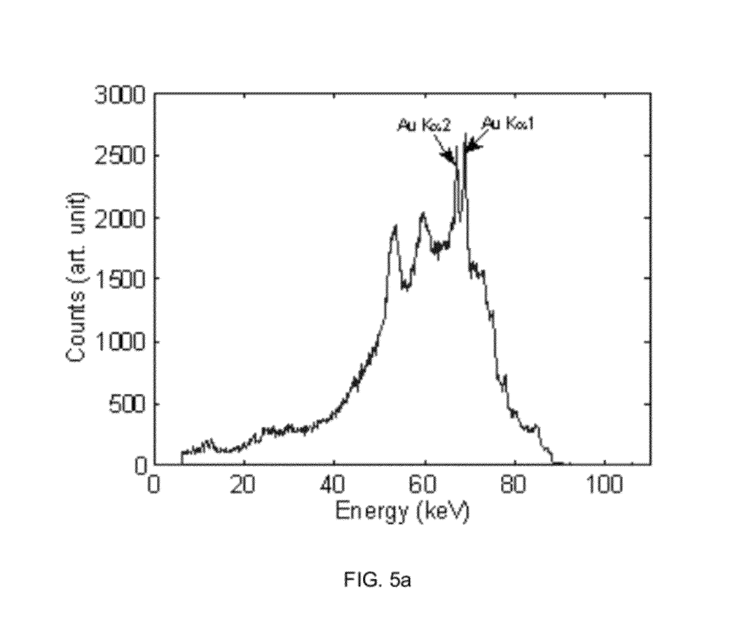

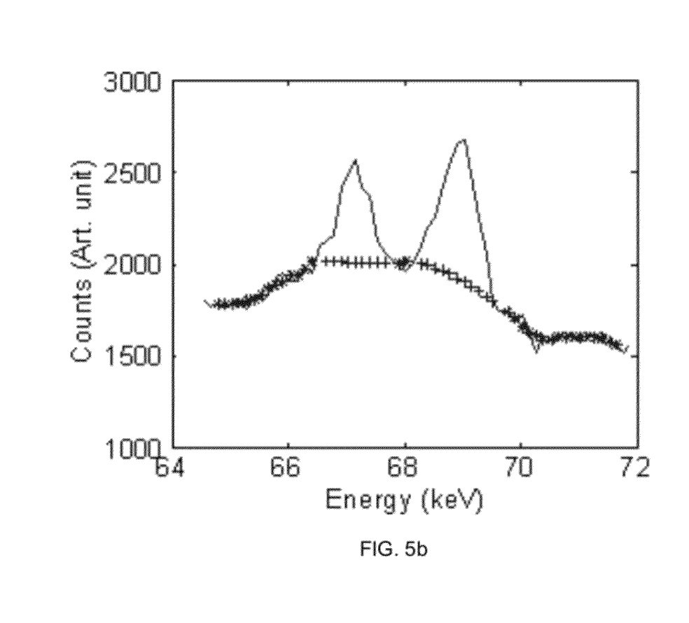

FIG. 5a shows a typical fluorescence spectrum from phantom 202 containing two cylindrical columns 204 and 206 containing GNPs at 1 and 2 weight % as measured by a CdTe detector at a certain angular position. As shown in FIG. 5a, the Au Kα fluorescence peaks at 67.0 and 68.8 keV were more prominent than Kβ peak at 77.9 keV. Since Au Kβ peak in the present data was not as clearly defined as Kα1 and Kα2 lines, it is likely not useful for data processing to relate fluorescence output to gold concentration within the phantom. Although, it should be noted that Au Kβ peak in some applications may still be used, and thus, the presently disclosed subject matter is not limited to processes or systems that exclude the Au Kβ peak data. FIG. 5b shows the expanded data around Au Kα fluorescence peaks. The total counts obtained by the detector at these energies resulted from several different processes which consisted of the excitation of GNPs and the Compton scattering responsible for Au Kα fluorescence and the background counts, respectively. Thus, a true Kα fluorescence was represented by the difference between the total counts and the background counts at the peaks. To convert the fluorescence to the concentration of gold in the phantom, the background should be removed before the isolation of Au Kα fluorescence.

For further noise reduction, an average filter with a window size of 5 was applied to the background counts for other off-peak ranges. Another way to minimize the uncertainty due to the fluctuation in counts would be an isolation of the peak ranges (typically 0.5 keV below and above the peaks), followed by a summation of the counts above the background within those ranges. Since the filtered background for the off-peak ranges was a smooth function of energy, a cubic spline function was used to fit the portion of the data for the off-peak ranges (64.5-66.5, 67.5-68.3, and 69.3-71.3 keV) and a piecewise cubic Hermite interpolating polynomial was applied to estimate the background counts for the peak ranges (66.5-67.5 and 68.3-69.3 keV). The filtered background and the interpolated data are shown with symbols (*) and (+), respectively, in FIG. 5b.

As described in Eq. (1), the attenuation correction on the measured counts (η_{Ei}), compensating for the variation in counts due to the change in the thickness of the phantom along the scattered and fluorescence beam path to the detector, provides the unattenuated background counts (bkg_{Ei}) within the unattenuated total counts (T_{Ei}) at E=Eᵢ as well. Thus, a difference between the unattenuated total counts and background counts becomes the true fluorescence counts from the elements of interest. After isolating the fluorescence peaks, the true fluorescence counts (F) can be expressed as

$$F = {\sum }_{Ei} ( {T}_{Ei} - {bkg}_{Ei} ) , \qquad ( 2 )$$

where T_{Ei} and bkg_{Ei} are the unattenuated total counts and the estimated unattenuated background counts at E=Eᵢ within the Au Kα peak ranges, respectively. The value of F is later used to create a projection data, bin-by-bin (i.e., sinogram).

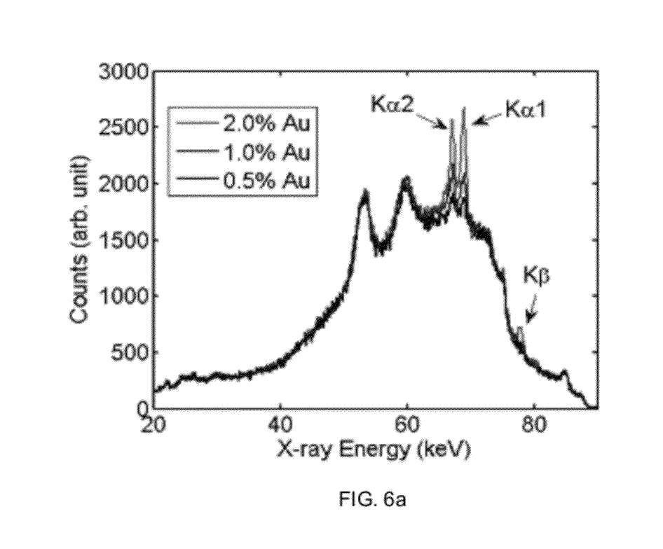

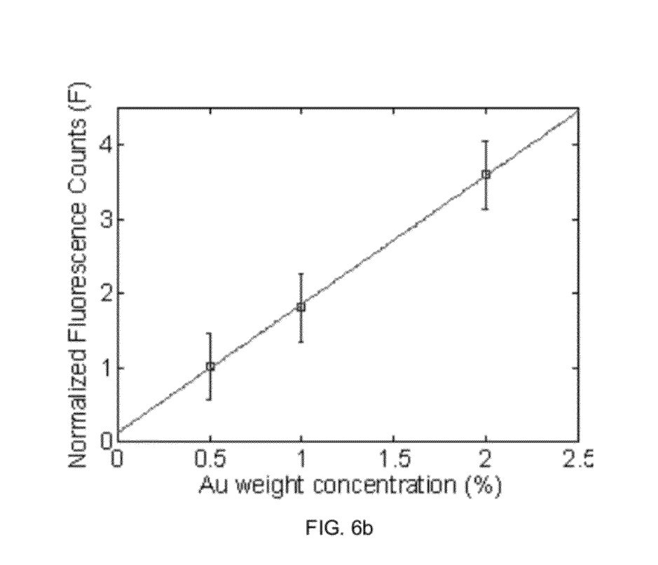

The linearity between the F value and the Au concentration in weight % was investigated. FIG. 6a shows the gold K-fluorescence spectra obtained for three different concentrations (0.5, 1.0, and 2.0 weight %) using a CdTe detector. The spectra collected show the amplitude of the Au Kα2 and Kα1 are proportional to the concentration of GNPs. FIG. 6b illustrates the F values in Eq. (2) as a function of the Au concentration. The linearity between the F value and Au concentration indicates the verification of the data processing for the quantification of GNPs. Linear fit (as shown in read line in FIG. 6b) can be used for determining the concentration of GNPs presented within a sample in question.

After data processing such as the attenuation correction, the background subtraction, and the fluorescence isolation as described before, the fluorescence data at the given laboratory coordinates (r, θ) were extracted for the projection data, bin-by-bin, under the first-generation tomographic acquisition geometry. The mathematical description of Au fluorescence tomography is built upon the experimental geometry described in FIG. 4. Consider a pencil beam impinging on an object (i.e., the cylindrical PMMA phantom in this case) as shown in FIG. 4. The function ρ(x, y) represents the Au concentration where (x, y) are the Cartesian coordinates fixed onto one slice of the phantom. A set of laboratory coordinates (r, s) are also defined as shown in FIG. 4 while (x, y) can rotate about the origin. With a rotational angle θ, the two coordinate systems can be transformed by

$$[ \begin{matrix}x \\ y\end{matrix} ] = [ \begin{matrix}cos θ & sin θ \\ - sin θ & cos θ\end{matrix} ] [ \begin{matrix}r \\ s\end{matrix} ] . \qquad ( 3 )$$

Since ρ(x,y) is the Au distribution in a section of the phantom and s the straight line along the beam axis; each line integral of ρ(x,y) along s is called the ray integral of the phantom, the totality of all these line integrals constitutes the Radon transform of ρ(x,y). Through the Radon transform, the measured fluorescence F from GNPs as a function of r at given angle θ in Eq. (3) can be described by

$$F ( r , θ ) = α {I}_{0} [ {\int }_{s} ρ ( x , y ) d s ] = α {I}_{0} [ {\int }_{s} ρ ( r cos θ + s sin θ , - r sin θ + s cos θ ) d s ] , \qquad ( 4 )$$

where I₀, α, and ds are the primary beam intensity, the fluorescence yield of Au, and the spatial interval along the primary beam path, respectively. The integration part in Eq. (4) is the Radon transform (R). Thus the sinogram p(r, θ) in polar coordinates (r, θ) is defined by

$$p ( r , θ ) = R [ ρ ( x , y ) ] = \frac{F ( r , θ )}{α {I}_{0}} . \qquad ( 5 )$$

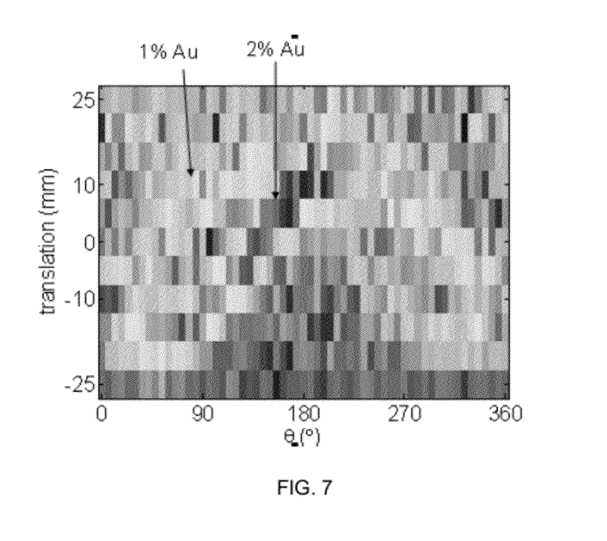

FIG. 7 shows the sinogram for Au K-fluorescence lines (67.0 and 68.8 keV) recorded from the phantom containing 1 and 2 weight % GNPs.

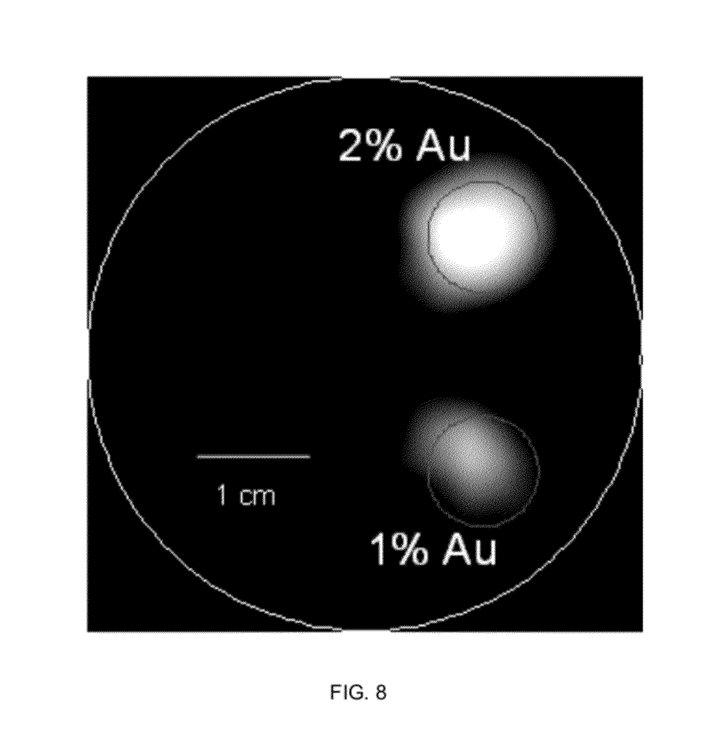

With the sinogram p(r, θ) presented in FIG. 7, the reconstructed image \hat{ρ}(x, y) was obtained by the inverse Radon transform as shown below

$$\hat{ρ} ( x , y ) = {R}^{- 1} [ p ( r , θ ) ] = {\int }_{0}^{2 π} p ( r , θ ) d θ , \qquad ( 6 )$$

where R⁻¹ are the inverse Radon transform. Eq. (6) was applied to reconstruct the distribution of GNPs inside the phantom. For visualization, the reconstructed image was resized to 400 by 400 pixels with an interpolation kernel of [4 4], i.e. the output pixel value is a weighted average of pixels in the nearest 4 by 4 neighborhood. FIG. 8 shows the reconstructed image of GNPs in the phantom.

A Monte Carlo (MC) model of an XFCT system according to the presently disclosed subject matter was created by using the MCNP5 code. This model was used to estimate x-ray dose to a phantom due to the entire XFCT scanning procedure. Specifically, x-ray dose to water due to an open unfiltered 110 kVp beam was calculated at a reference point (i.e., 13 cm from the x-ray source). The calculated dose was normalized to an ionization chamber-measured dose rate in water (0.97 Gy/min) at the same point to obtain the dose conversion factor for MC results. Subsequently, MC calculations were repeated to determine x-ray dose at the center of phantom under the current Pb-filtered pencil beam geometry properly simulating an actual scanning process at a given projection angle as described earlier (i.e., 1 minute irradiation of phantom by each of 11 pencil beams). Although the current experiment was performed with a PMMA phantom, water was chosen as the phantom materials for these calculations to provide dose estimation more relevant to in-vivo experiments. During MC calculations with the MCNP code, x-ray doses were scored within a cylindrical volume (1 cm in height and 0.5 cm in diameter) along the longitudinal axis of the phantom using the energy deposition tally (i.e., F6). The statistical uncertainty (1σ) in calculated doses was less than 2% after simulating 3×10⁹ particle histories.

The current MC calculations found x-ray dose at the center of phantom made of water instead of PMMA to be 0.67 cGy per projection. Note this value accounted contributions from all 11 pencil beams at each projection angle covering the entire phantom. For a full 360° scanning at 6° intervals (i.e., 60 projections), therefore, the total x-ray dose to the center of phantom would be about 0.4 Gy (i.e., 0.67 cGy/projection×60 projections=40.2 cGy). As explained earlier, the current experiment utilized only one detector and, consequently, required a repetition of the entire scanning process at 5 different detector positions along the axis parallel to the pencil beam direction to fully acquire fluorescence signal along each pencil beam path. Thus, under the current experimental setup and scanning procedure, the total x-ray dose to the center of phantom would be about 2 Gy (i.e., 40.2 cGy/scan×5 scans=201 cGy).

To attempt to reduce scanning time, an alternate setup may be to use more than one detector. For example, if the current experiment was repeated with 5 detectors or an equivalent array detector, there may be an immediate reduction of scanning time by a factor of 5 (i.e., 30 hours→6 hours). To possibly further reduce scanning time, an alternate exemplary and non-limiting embodiment may be to use quasi-monochromatic x-ray beams. In principle, the use of monochromatic x-ray beams will enable a quicker detection of Au K fluorescence peaks by improving the signal-to-background ratio. As a practical alternative to monochromatic x-ray beams, quasi-monochromatic beams can be obtained from a proper conversion of polychromatic x-ray beams using crystals such as highly oriented pyrolitic graphite (HOPG). An adoption of quasi-monochromatic x-ray beams may also help further lower the current detection limit (i.e., 0.5% GNP concentration within the sample by weight) by improving the efficiency of K-fluorescence x-ray production from GNPs. In addition, to increase the amount of information given per a given scan or to increase the functionality of the system, a micro-CT system may be integrated with the presently disclosed XFCT system to accomplish so-called “multi-modality” imaging with a single system.

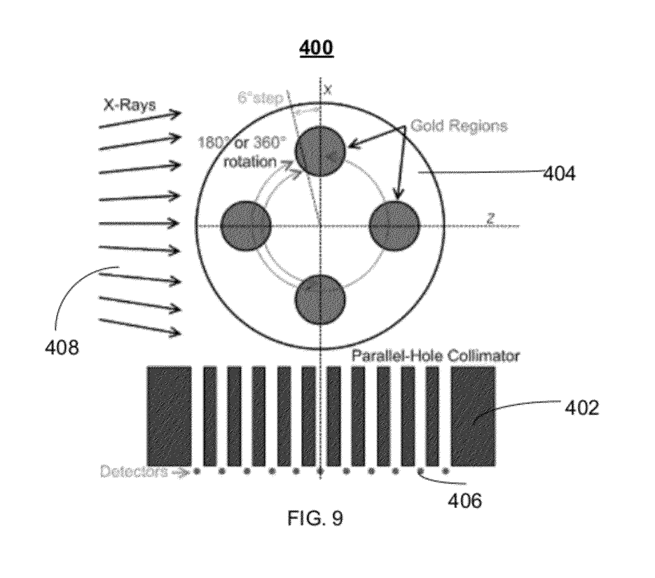

To overcome the technical issues associated with the pencil beam implementation described earlier, XFCT adopting cone/fan beam geometry can also be developed. FIG. 9 is an illustration showing system 400 that uses a cone beam x-ray source. As shown in FIG. 9, parallel-hole collimator 402 is used between imaging object 404 and detector array 406. Cone beam 408 of photons is incident on the imaging object 404 along the z-axis (or beam central axis). Data are acquired by detector array 406. Although not shown in FIG. 9, a transmission detector (e.g., detector array) can be located along the z-axis (i.e., distal side of an imaging object 404 with respect to the x-ray beam) to detect x-rays transmitted through an imaging object 404 for transmission CT imaging and attenuation corrections. In the present exemplary and non-limiting example, the individual detectors (shown as dots) of detector array 406 are positioned behind collimator 402. Collimator 402 has a series of parallel pinhole openings with a diameter of 2.5 mm. Because of the parallel-hole collimation, each detector of detector array 406 has a “view” inside imaging object 404 along the x-axis at an angle of approximately 90° relative to the beam central axis in an exemplary embodiment. Rather than spatial discrimination being accomplished by using a pencil beam x-ray source, in system 400, spatial discrimination of the imaging object 404 is accomplished by using detector collimation. Collimation system 402 accepts photons along the projected direction and is configured to reduce the background. As an additional advantage that may be found using the configuration of system 400, the detection limit may also be further lowered (e.g., 0.1 wt % or lower), especially in connection with the use of quasi-monochromatic x-ray beams. Due to a possibly shorter scanning time with cone/fan beam implementation, x-ray dose to imaging objects may be lowered as well.

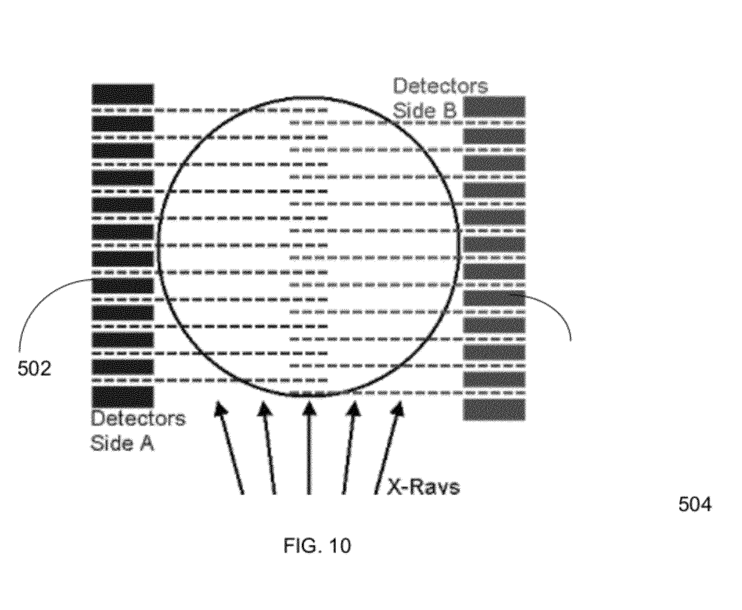

Further efficiencies in the exemplary system 400 may be achieved by using a second set of detector arrays, as shown in FIG. 10. First parallel-hole collimator 502 is offset from a second parallel-hole collimator 504 in order to decrease the effective pixel pitch and increase resolution in reconstructed XFCT images. Also, this arrangement will help reduce scanning time and x-ray dose further by requiring a less number of projections to reconstruct XFCT images, while attempting to ensure no significant change in the image quality.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims

What is claimed is:

1. A method of performing x-ray fluorescence computed tomography of a plurality of nanoparticles within a cell, comprising:
introducing into a cell a plurality of nanoparticles having affinity for the cell;
energizing an x-ray source to introduce a polychromatic x-ray source at diagnostic energy levels to induce x-ray fluorescence of the plurality of nanoparticles;
detecting the x-ray fluorescence of the plurality of nanoparticles;
determining a concentration of the plurality of nanoparticles within the cell; and
determining a location of a portion of the plurality of nanoparticles within the cell.

2. The method of claim 1, wherein the plurality of nanoparticles are gold, silver, aluminum, platinum, copper, ruthenium, zinc, iron, nickel, calcium, lithium, sodium, magnesium, potassium, scandium, titanium, vanadium, chromium, manganese, cobalt, gallium, strontium, niobium, molybdenum, palladium, indium, tin, tungsten, rhenium, or gadolinium, or combinations thereof.

3. The method of claim 1, wherein the plurality of nanoparticles are gold.

4. The method of claim 1, wherein the plurality of nanoparticles have hydrodynamic diameters ranging from about 1 nanometer to about 1000 nanometers.

5. The method of claim 1, wherein the plurality of nanoparticles have hydrodynamic diameters ranging from about 1 nanometer to about 150 nanometers.

6. The method of claim 1, wherein the cell is a cancerous tumor.

7. The method of claim 1, wherein the diagnostic energy levels are in a range from about 10 kVp to about 180 kVp.

8. The method of claim 1, wherein the diagnostic energy levels are in a range from about 80 kVp to about 150 kVp.

9. The method of claim 1, further comprising generating a computed tomography image.

10. A system configured for x-ray fluorescence computed tomography of a plurality of nanoparticles within a cell, comprising:
a polychromatic x-ray source configured to provide x-ray energy at diagnostic energy levels;
a first photodiode detector at a first position configured to detect fluorescence of the plurality of nanoparticles within the cell; and
shielding disposed proximate to the detector to reduce background x-ray photons.

11. The system of claim 10, wherein the photodiode detector comprises a conically shaped shield or a pin-hole type collimator.

12. The system of claim 10, wherein the shield is positioned for receiving a beam of x-ray fluorescence caused by the x-ray energy.

13. The system of claim 10, wherein the beam emanating from the x-ray source is collimated and filtered.

14. The system of claim 10, wherein the detector is placed at an angle approximately 90 degrees to the general direction of the x-ray beam from the x-ray source.

15. The system of claim 10, further comprising a means for rotating and translating the x-ray source and detector relative to the cell or a means for rotating and translating the cell relative to the x-ray source and detector, or combinations thereof.

16. The system of claim 10, further comprising an analyzer to provide for the ability to select one or more x-ray fluorescence peaks detected by the detector.

17. The system of claim 16, wherein the one or more energy peaks are K- or L-fluorescence lines of nanoparticles or both.

18. The system of claim 10, further comprising a second detector at a second position for detecting fluorescence of the plurality of nanoparticles within the cell.

19. The system of claim 10, wherein the detector is an equivalent array detector.

20. The system of claim 10, wherein x-ray energy is quasi-monochromatic beams.

21. The system of claim 20, wherein the x-ray energy is converted using highly oriented pyrolitic graphite.

22. The system of claim 10, wherein the system further comprises a micro-CT system or a transmission detector for transmission CT imaging of the cell.

23. The system of claim 10, further comprising a filter between the x-ray source and the cell to modify the incident x-ray energy spectrum.

24. The system of claim 23, wherein the filter is primarily made of lead or other materials capable of reducing x-ray photons with energies below K- or L-absorption edges of metal nanoparticles.

25. The system of claim 10, wherein the polychromatic x-ray source is a pencil beam source or a cone/fan beam source.

26. The system of claim 10, further comprising a plurality of second photodiode detectors positioned in an array configuration.

27. The system of claim 26, wherein the shielding is collimated.

28. An x-ray fluorescence computed tomography image generated by:
introducing into a cell a plurality of nanoparticles;
energizing an x-ray source to introduce a polychromatic x-ray beam at diagnostic energy levels to induce x-ray fluorescence of the plurality of nanoparticles;
determining a concentration of the plurality of nanoparticles within the cell; and
determining a location of the cell; and
generating the computed tomography image from the concentration and location of the plurality of nanoparticles within the cell.

29. The image of claim 28, wherein the plurality of nanoparticles are gold, silver, aluminum, platinum, copper, ruthenium, zinc, iron, nickel, calcium, lithium, sodium, magnesium, potassium, scandium, titanium, vanadium, chromium, manganese, cobalt, gallium, strontium, niobium, molybdenum, palladium, indium, tin, tungsten, rhenium, or gadolinium, or combinations thereof.

30. The image of claim 28, wherein the cell is a cancerous tumor.

31. The image of claim 28, wherein the diagnostic energy levels are in a range from about 10 kVp to about 180 kVp or in a range from about 80 kVp to about 150 kVp.

32. The image of claim 28, wherein introducing into a cell a plurality of nanoparticles is via passive or active targeting.
